(19) United States
(12) Patent Application Publication
(10) Pub. No.: US 2026/0235931 A1
(43) Pub. Date: Aug. 13, 2026

(54) SYSTEM AND METHOD FOR ILLUMINATION OF AN IMAGED SCENE USING A PROGRAMMABLE LIGHT SOURCE

(71) Applicant: Cognex Corporation, Natick, MA (US)

(72) Inventors: David Y. Li, West Roxbury, MA (US); Lowell D. Jacobson, Grafton, MA (US); Lei Wang, Wayland, MA (US)

(21) Appl. No.: 19/471,786

(22) PCT Filed: Apr. 3, 2024
(86) PCT No.: PCT/US2024/022864

§ 371 Date: Oct. 2, 2025

Related U.S. Application Data
(60) Provisional application No. 63/456,688, filed on Apr. 3, 2023.

(51) Int. Cl. G03B 15/02

(52) U.S. Cl. CPC G03B 15/02

(57) ABSTRACT

A vision system is described that acquires images in a scene with a camera assembly 110 and analyzes features in the acquired images with a vision system processor 120. It includes an illumination panel 132, having a grid of individually addressable light sources, of at least one color of light that generates an illumination pattern. The panel defines a width and a length, in which the length is greater than the width and the grid is oriented approximately in a first plane. A beam splitter 162 allows an optical axis OA of the camera assembly or the grid direction of light propagation to extend through the beam splitter onto the scene. The light sources can comprise multicolor LEDs. A controller 130 can address the multicolor LEDs via a serial data bus. A controller can further synchronize the LED display pattern and image acquisition.

### RELATED APPLICATION

This application claims the benefit of co-pending U.S. Provisional Application Ser. No. 63/456,688, entitled SYSTEM AND METHOD FOR ILLUMINATION OF AN IMAGED SCENE USING A PROGRAMMABLE LIGHT SOURCE, filed Apr. 3, 2023, the teachings of which are expressly incorporated herein by reference.

### FIELD OF THE INVENTION

This invention is related to machine vision systems and more particularly to illumination of an imaged scene.

### BACKGROUND OF THE INVENTION

Machine vision systems (also simply termed “vision systems”) use image acquisition devices that include camera sensors to deliver information on a viewed subject. The vision system then interprets this information according to a variety of algorithms to perform a programmed and/or trained decision-making and/or identification function. An image of an object containing features of interest to the system is acquired by an on-board image sensor (also termed, simply an “imager” or “sensor”) in the visible, and/or near-visible light range under appropriate illumination, which can be based upon ambient light, and/or light provided by an internal and/or external illuminator.

A common task for vision systems is the inspection of parts and associated surfaces for cosmetic and/or structural defects. Various processes/algorithms are employed by an image processor to analyze acquired images, and derive information based upon vision system tool results and/or trained patterns (for example, using artificial intelligence (AI) based processes). An exemplary supplier of vision system hardware and software is Cognex Corporation of Natick, MA.

The inspection of cosmetic defects on (e.g.) electronic devices poses a challenge due to the use of multiple materials with different colors and surface finishes. Prior vision system arrangements have used illumination assemblies that vary color, angle, and other parameters of projected/presented light in synchronization with capture of image frames of an object to provide a more complete data set for analysis of features associated with the object. However, these illumination assemblies may be limited in the colors and/or patterns that they can produce/present, and entail significant additional costs to the overall vision system due to complexity, among other factors.

### SUMMARY OF THE INVENTION

This invention overcomes disadvantages of the prior art by providing a system and method for use in inspecting parts and surfaces that can employ a versatile, programmable illumination assembly using individually addressable LEDs (or similar light sources) to form a grid of pixels. The color and brightness of each pixel can be programmed independently by a controller in communication with the vison system processor, providing the ability to create custom lighting patterns. The illumination assembly can employ a beam splitter positioned at (e.g.) a 45-degree angle, which reflects light, or the viewing angle of the camera, onto the object being inspected, enabling perpendicular viewing of the scene/object under inspection by a camera image sensor. The vision system arrangement can be programmed to generate sinusoidal illumination patterns as typically required for phase-shift deflectometry, as well as simulate, with the illumination assembly, a range of lighting configurations, including bar light, ring light, and direct overhead lighting. The vision system processor and interconnected illumination controller can operate together to synchronize the propagation of the LED display pattern and image acquisition. More particularly, the vision system camera is adapted to acquire images in association with discrete illumination patterns and/or colors. Notably, the programmable grid can be a commercially available component that provides a cost-effective accessory to a vision system camera arrangement, which is highly variable in generated pattern and/or color, and can adapt in real time to analyze features in acquired images of a scene. The resulting acquired images can be variously combined to enhance certain features for analysis in a more efficient and cost-effective manner than more-limited illumination assemblies.

In an illustrative embodiment, a vision system and method can provide a vision system camera configured to acquire images of a scene at a predetermined focal plane, and an illumination assembly having a grid of individually addressable light sources (defining one or more emission spectra). A beam splitter can be positioned at an angle with respect to the predetermined focal plane such that either an optical axis of the vision system camera, or an illumination from the illumination assembly, extends through the beam splitter onto the scene. At least one processor can be in communication with the vision system camera and the illumination assembly. The illumination assembly can be configured to control individual intensities of the individually addressable light sources (generally arranged to provide dynamic spatiospectral illumination), so as to produce a discrete lighting pattern and to control image acquisition in association with the discrete lighting pattern. Illustratively, at least one processor can be configured to control image acquisition by generating image acquisition triggers to the vision system cameras, synchronized with a presentation of the discrete lighting pattern. The individually addressable light sources can comprise at least one of multicolor LEDs, IR LEDs, or UV LEDs. The at least one processor can be constructed and arranged to address the individually addressable light sources via a serial data bus. The at least one processor can be configured to generate a plurality of static or dynamic illumination patterns to illuminate the scene in an emission spectra. The vision system camera can be triggered to acquire the images based upon illumination by each of a plurality of static or dynamic illumination patterns. The grid can comprise a plurality of discrete arrays of individually addressable light sources connected by the serial data bus. The dynamic illumination patterns can include a plurality of spatial sinewave gratings, each with distinct phase, spatial-frequency, and angle. The dynamic illumination patterns can define a plurality of lines, each having a position and orientation. The grid and the beam splitter can be enclosed in a housing with openings along the optical axis. Illustratively, a diffusive surface can be provides, which diffuses light from the individually addressable light sources. The at least one processor can be constructed and arranged to vary the discrete lighting pattern based upon characteristics of features in the scene, and acquire images associated with each variation, and/or constructed and arranged to combine the acquired images and analyze features therein. The at least one processor can be constructed and arranged to vary the discrete lighting pattern based upon analyzed features in prior acquired images of the scene. The illumination assembly and the at least one processor can be constructed and arranged to, respectively, present the discrete lighting pattern, and process the acquired images, based upon computational imaging techniques. The computational imaging techniques can include at least one of deflectometry or photometric stereo techniques. The emission spectrum can be at least one of a visible spectrum, IR spectrum, or UV spectrum, and/or the grid can comprise a width greater than a length. The angle of the beam splitter with respect to the predetermined focal plane can be approximately 45 degrees (e.g. varying approximately +/−1 degree).

In an illustrative embodiment, a system and method for illuminating a scene as imaged by a vision system camera at a predetermined focal plane is provided. It can include an illumination assembly comprising a grid of individually addressable light sources. A beam splitter can be positioned at an angle with respect to the predetermined focal plane such that either an optical axis of the vision system camera or an illumination from the illumination assembly extends through the beam splitter onto the scene. At least one processor can be in communication with the illumination assembly and the vision system camera. The processor can be configured to control individual intensities of the individually addressable light sources to produce a discrete lighting pattern, provide control signals to the vision system camera based on the discrete lighting pattern.

In an illustrative embodiment, a method for illuminating a scene as imaged by a vision system camera at a predetermined focal plane is provided. The method produces a discrete lighting pattern onto the scene by controlling individual intensities of individually addressable light sources arranged in a grid, and directing either an optical axis of the vision system camera or illumination from the individually addressable light sources through a beam splitter onto the scene. The method provides control signals to the vision system camera based on the discrete lighting pattern. Illustratively, the control signals to the vision system camera can be synchronized with presentation of the discrete lighting patterns by the grid. A plurality of static or dynamic illumination patterns can illuminate the scene in one or more emission spectra. The dynamic illumination patterns can be presented to provide a plurality of spatial sinewave gratings, each with a distinct phase, a spatial-frequency, and an angle. The discrete lighting pattern can be varied based upon characteristics of features in the scene, and providing the control signals to the vision system camera in association with each variation. Illustratively, acquired images from each variation can be combined, and features therein can be analyzed. The discrete lighting pattern can be varied based upon analyzed features in prior acquired images of the scene. The discrete lighting pattern can be presented, and the acquired images can be processed, based upon computational imaging techniques. The computational imaging techniques can include at least one of deflectometry techniques or photometric stereo techniques.

### BRIEF DESCRIPTION OF THE DRAWINGS

The invention description below refers to the accompanying drawings, of which:

FIG. 1 is a diagram showing a vision system arrangement including a camera assembly imaging an exemplary object in conjunction with a programmable illumination assembly and associated housing with beam splitter, according to an illustrative embodiment;

FIG. 2 is a diagram showing the components of the arrangement of FIG. 1, including relative optical paths;

FIG. 2A is a diagram showing an alternate arrangement of components and relative optical paths, in which the position of the illumination head assembly and the camera are reoriented with respect to the beam splitter of FIGS. 1 and 2 to achieve similar or identical effects thereof;

FIG. 3 is a diagram showing incident light relative to the object under inspection along the width dimension of the illumination head assembly of the arrangement of FIG. 1;

FIG. 4 is a diagram showing incident light relative to the object under inspection along the wider, length dimension of the illumination head assembly of the arrangement of FIG. 1;

FIG. 5 is an exemplary LED illumination array for use as part of the illumination head assembly of FIG. 1;

FIGS. 6-14 are diagrams showing each of a plurality of exemplary, geometric light patterns in one or more colors generated by the illumination head assembly to illuminate an imaged scene in the arrangement of FIG. 1;

FIGS. 15 and 16 are, respectively, diagrams showing a moving (phase-shifting) sinusoidal light pattern in one or more colors, in each of two opposing diagonal orientations, generated by the illumination head assembly to illuminate an imaged scene in the arrangement of FIG. 1;

FIG. 17 is a generalized procedure for employing the arrangement of FIG. 1 to illuminate an object and acquire images therefrom so as to generate results; and

FIG. 18 shows a side-by-side diagram of a conventional vision system arrangement with a plurality of discrete light sources to generate desired illumination effects versus a vision system arrangement in accordance with the general principles of FIG. 1.

### DETAILED DESCRIPTION

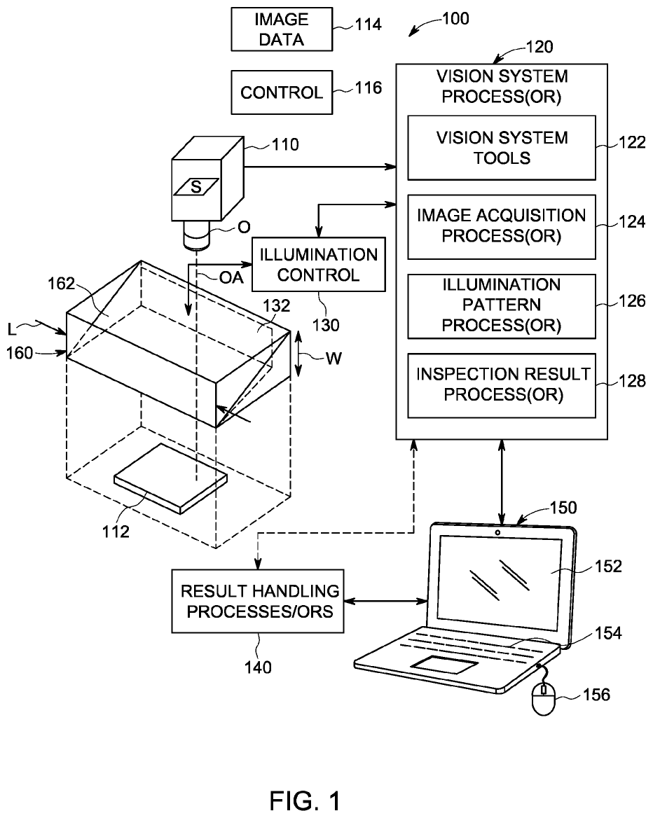

Reference is made to FIG. 1, which shows a vision system arrangement 100 according to an exemplary implementation. The arrangement 100 comprises a camera assembly 110 that can be any acceptable type of camera suitable for a vision system. The camera assembly 110 can be based upon, for example, a (e.g.) CCD or CMOS image sensor S, also referred to as a “sensor” or “imager”. The sensor S receives light from an imaged scene containing an object under inspection 112 through appropriate optics O. The object 112 can be any item requiring inspection. The camera 110 in this example is aligned with its optical axis OA approximately perpendicular to the prevailing plane of the object 112 (and underlying supporting surface). The sensor S can be a monochromatic (e.g. grayscale) or multispectral (e.g. RGB) sensor of predetermined resolution (e.g. 12 Megapixels). The sensor can also be adapted to detect light in the near-visible spectrum-for example IR and/or UV. In various examples, the object under inspection can be any acceptable shape and/or surface configuration.

The camera assembly 110 includes an image processor 120 within its housing or partially or fully remote from its housing that receives and analyzes transmitted (and optionally stored) image data 114 from the sensor S. The processor uses various vision system tools 122, including, but not limited to, edge finders, calipers, blob tools and/or artificial intelligence (AI) based pattern recognition tools that are trained on various expected patterns. Images are acquired based upon control signals 116 that can include triggers that cause the sensor S to generate image data 114 from the scene using an image acquisition process(or). As described below, triggers can be coordinated with illumination, which is managed by an illumination process(or) 126 that communicates with an illumination controller 130 and associated LED (or other appropriate light source) illumination panel 132. Results of image acquisition and analysis are derived by an inspection result process(or) 128 that provides data to downstream processes/ors 140. The arrangement of functional modules, processes/ors can be varied and/or the functions of various modules can be redistributed as appropriate to the system hardware and software. It is expressly contemplated that the illumination controller 130 can transmit appropriate trigger signal(s) to the camera assembly 110 to synchronize the displayed illumination pattern and image acquisition—as described in further detail below.

The processor 120 can be part of, and/or provide results to, a remote computing device (e.g. a PC, laptop, tablet, smartphone or cloud computing arrangement) 150 that can include an appropriate user interface with a display (e.g. touchscreen 152) and data entry components (e.g. keyboard 154 and mouse 156). The computing device 150 can communicate with the vision system process(or) 120 over an appropriate internal or external link (e.g. WiFi (802.11(g)), LAN, USB 2.0, USB 3.0, etc.) and can be used to view results, program and monitor operation of the vision system.

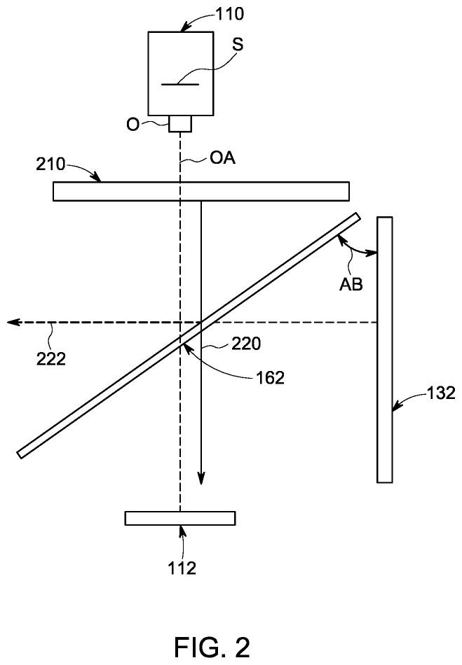

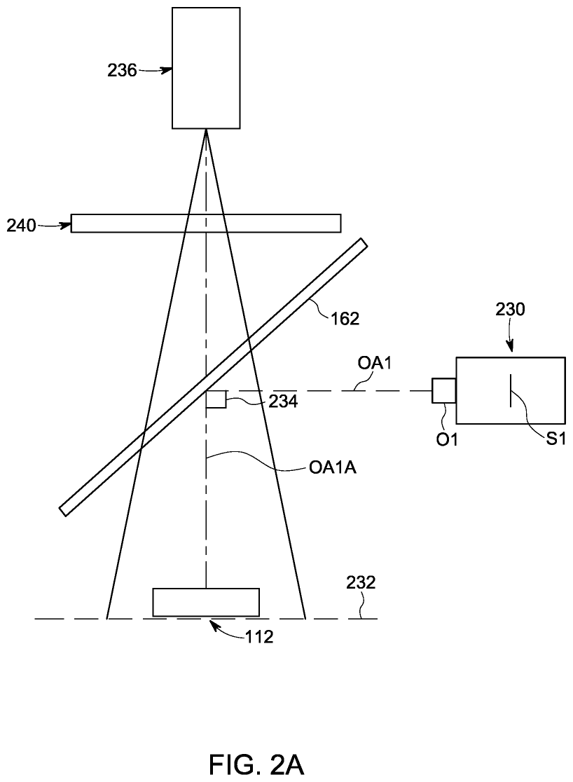

Notably, and with further reference to FIG. 2, the arrangement 100 includes an illumination head assembly 160 that contains the illumination panel 132 in an orientation that defines a plane approximately parallel to the camera axis OA. The panel 132 generates a grid or field of light (along a direction of propagation 222) into a beam splitter 162 of (e.g.) conventional design. In this exemplary embodiment, the beam splitter is oriented at a 45-degree angle (AB in FIG. 2) with respect to the camera axis OA and the direction of light propagation 222. While a 45-degree beam splitter is employed by way of example, such angle is only one of a variety of ways of implementing a beam splitter (for example, various folded mirrors and/or prisms) which should be clear to those of skill. Additionally, as used herein the terms “45 degree”, “45 degrees”, and/or their equivalents can define an approximate range of angles about 45 degrees—for example, the actual angle varying by +/−1 degree. By operation of the beam splitter to reflect the propagated light, it defines a virtual grid 210 (FIG. 2) that, at a similar distance along the camera axis OA, propagates light (arrow 220) onto the object 112. Light reflected from the object 112 is transmitted back through the beam splitter 162 along the optical axis OA to the camera assembly 112.

The head assembly 160 can be any acceptable housing structure that effectively maintains the main components (illumination panel 132 and beam splitter 162) in a fixed relationship relative to the camera assembly 110. It can include appropriate transparent window(s) on, for example, the top and/or bottom surfaces so as to allow light to pass onto the object 112 and return to the camera optics O and sensor S. Appropriate optical filter and/or anti-glare coatings can be provided to such window(s) to condition the transmitted and received light in a manner clear to those of skill. Likewise, the walls of the housing can include an opaque (e.g. black) coating to avoid back-reflection. Similarly, in some exemplary embodiments, a diffuser and/or other filter, of conventional or custom design, can be (optionally) provided over the illuminator grid. The diffuser and/or other filter can, for example, suppress the visibility of individual LED emitters while preserving the pattern of light produced by the plurality of LEDs. The housing 160 can also include heatsinks and/or other heat dissipation devices (e.g. vents and fans) to remove heat generated by the panel 132. In some implementations, the housing can include mounting fixtures that facilitate attachment of the camera assembly thereto at an appropriate distance from the optical plane.

Reference is also made to FIG. 2A, which shows an alternate arrangement of operational components relative to that depicted in FIGS. 1 and 2. As shown, the camera assembly 230, having a sensor S1 and optics assembly O1, is oriented with optical axis OA1 at a right angle to the perpendicular of the scene surface 232. The optical axis OA1A is, thus, turned by a right angle 234 by the beam splitter 162. The depicted orientation defines a virtual camera 236 aligned with the perpendicular optical axis OA1A. The illumination panel 240 in this arrangement is aligned along the perpendicular axis and passes light through the beam splitter 162 onto the scene 232 and associated object 112. The arrangements of either FIGS. 1 and 2 or FIG. 2A provide a compact structure in which the camera view and illumination are aligned along a common axis adjacent the imaged scene/object. Note that the above-described housing (160 in FIG. 1) can be appropriately adapted for the component arrangement of FIG. 2A in a manner clear to those of skill. For example, the housing 160 in FIG. 1 can be rotated 90 degrees about the lengthwise direction and the camera relocated so that its optical axis is at a right angle to its depicted orientation. While the following description may refer to the component arrangement of FIGS. 1 and 2, for the purposes of this description, reference to the camera and illumination panel should be taken to interchangeably refer to either the arrangement of FIGS. 1 and 2, or FIG. 2A.

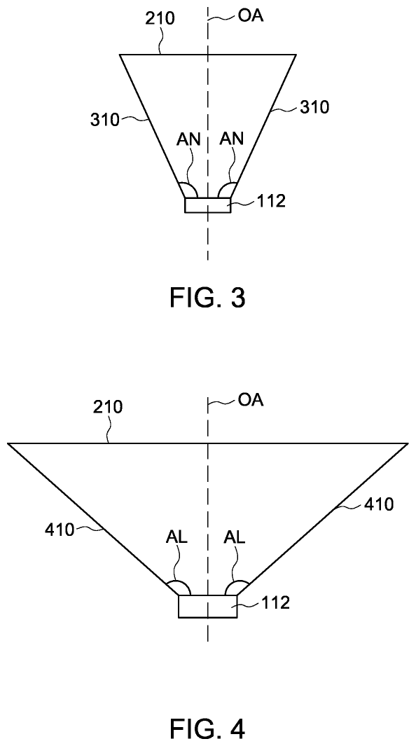

The illumination panel 132 (or 240), beam splitter 162 and associated housing 160 are collectively constructed with a length L that is greater than the width W so as to provide an aspect ratio not equal to unity (W/H>1). With reference to FIG. 3, as shown, light emitted by the virtual grid 210 incident on the edges (boundaries 310) of the object 112 defines a maximum angle AN with respect to the narrower width dimension of the illuminator and virtual grid 210. However, as shown in FIG. 4, in the longer length dimension L, the virtual grid 210 of the boundaries 410 allow for a shallower angle AL for incident light. The object 112 can be oriented so that features imaged by the camera 110 (or 230) benefitting from lowered angle illumination are oriented with respect to the lengthwise dimension of the illumination head assembly 160. Alternatively, the object can be manually or mechanically rotated to a plurality of different rotational orientations while illuminated, with one or more images acquired at each orientation. The width and length of the panel 132 is highly variable. In an exemplary, non-limiting, embodiment the length is at least twice the width (i.e. a 2×4 rectangle)—for example, approximately 140×280 millimeters. Notably, by using a beam splitter, the light can be fully overlaid onto the object, free of interference from the camera assembly (in contrast to a lens-surrounding ring illuminator). This arrangement, along with the use of a wider, rectangular geometry for the illuminator reduces the working distance for the resulting virtual grid onto the object.

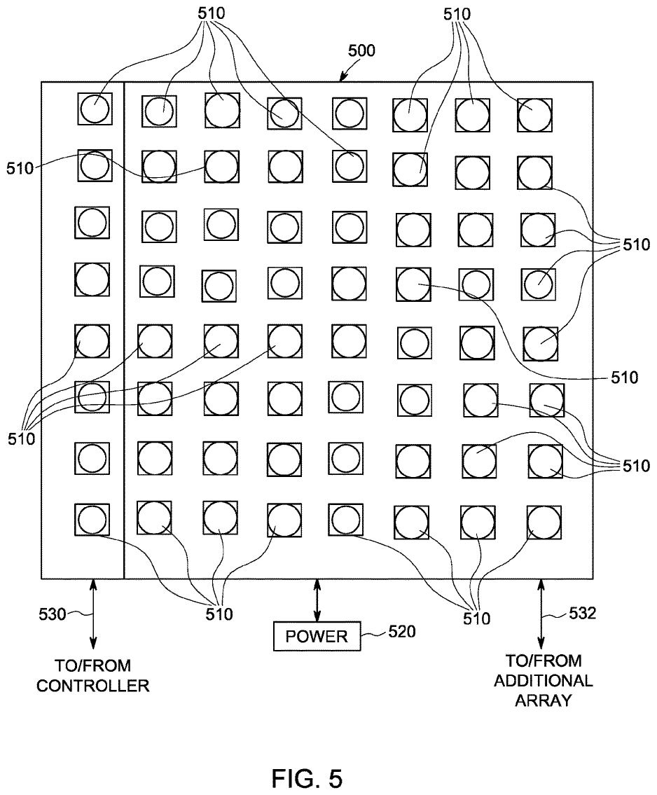

The illumination panel 132 in this example comprises a plurality of arrays of multicolor LED sources on printed circuit (or similar) boards. Notably, the LEDs are arranged in a rectilinear grid. FIG. 5 shows an exemplary array 500 for use in the panel 132. In the exemplary depiction, a random pattern of LEDs 510 have been switched on or off, and various switched-on colors are shown by way of shading in the diagram. The non-limiting, exemplary array 500 comprises a model WS2812, grid of 64 addressable RGB LEDs, arranged in an 8×8 matrix and having a square size of 67.5×67.5 millimeters and 8.44-millimeter spacing between LEDs 510. The exemplary array 500 is available under the brands ElectroMage and Pixelblaze by Hencke Technologies, Inc. of Vancouver, WA. The array 500 advantageously employs a commercially available microcontroller assembly that can be part of the depicted illumination controller 130, and can be interfaced via standard communication protocols, such as LAN, WiFi, USB, etc. The array is powered (520) by an appropriate power source (e.g. 5 VDC) that can be part of the microcontroller or separate. More particularly, the control protocol for the array 500 employs a serial bus architecture that individually addresses compact, on-board microcontrollers associated with each LED and thereby switches the individual LEDs on or off within a timed (clocked) bus cycle. The switching operation controls intensity, in this example, using pulse-width modulation (PWM) such that actual input voltage to each LED is relatively constant, while the duty cycle of the LED's on cycle is modulated. Notably, each array has an input control bus connection 530 and output control bus connection 532 that allows each array to be daisy-chained to additional, downstream arrays, from an immediate upstream array, so as to define the overall panel, with a first array connected to the controller 130. This arrangement, thus, simplifies control, increases speed of illumination and reduces system costs by employing commercially available illumination components. Moreover, the use of multicolor LEDs allows for a modulation of color in a manner that helps to accentuate differing color features on the object, and variation of the illumination pattern on the object during respective image acquisition frames.

Note that the light propagated by the light sources of the panel can generate light in one or more emission spectra, which can be within the visible spectrum, and/or can be within the near-visible spectrum-for example IR or UV. The term light shall be taken broadly to include these wavelengths and the image sensor(s) can be adapted, in a manner known in the art, to sense within that range.

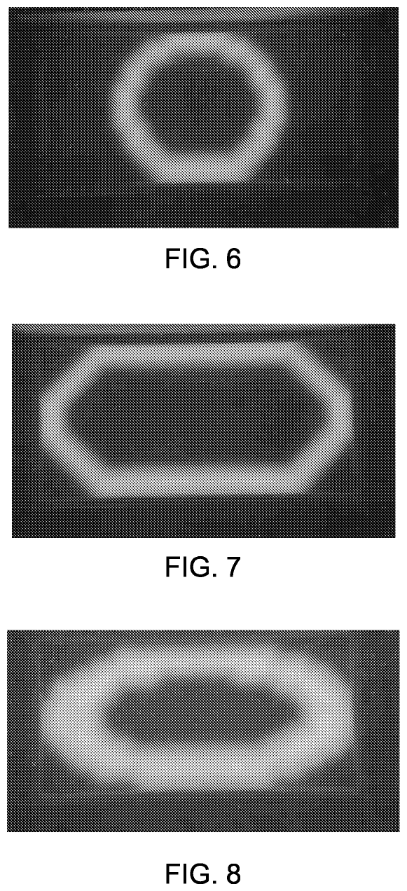

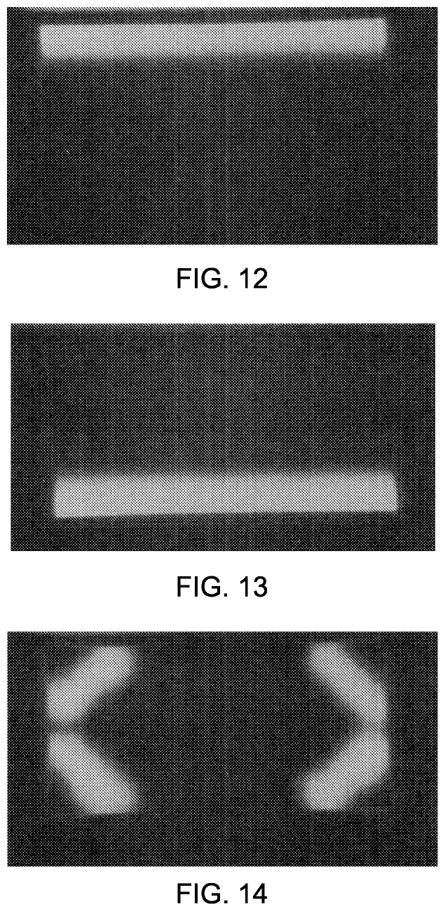

Variation of the illumination pattern on an object under inspection is shown by way of non-limiting example in FIGS. 6-16. The pattern illuminating the scene/object can be varied by addressing various LEDs in the overall grid, specifying which are switched on or off and an intensity and color thereof. The color of the grid pattern can be monochromatic-for example, white, green, blue, red, green violet, etc., or can vary across the pattern. Images can be acquired by the camera assembly as each pattern is presented. As such, each successively presented pattern can be triggered by the vision process(or) or, the illuminator's controller can be monitored to derive trigger signals as each pattern is presented. Images can be individually analyzed and provide results and/or image data from one or more images can be combined to allow generation of results.

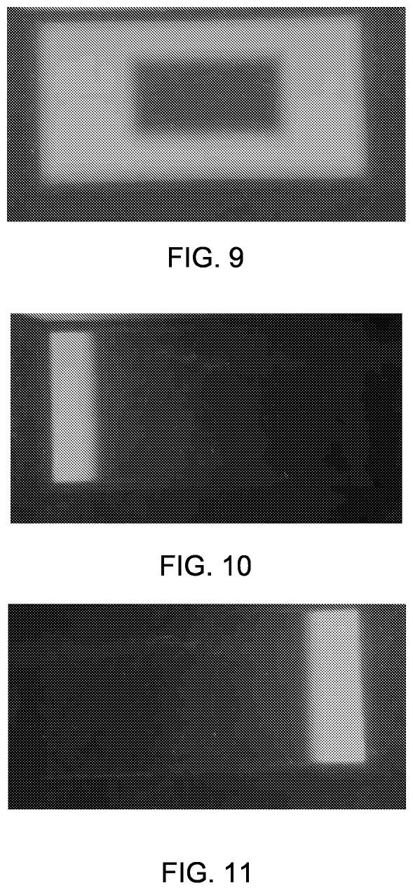

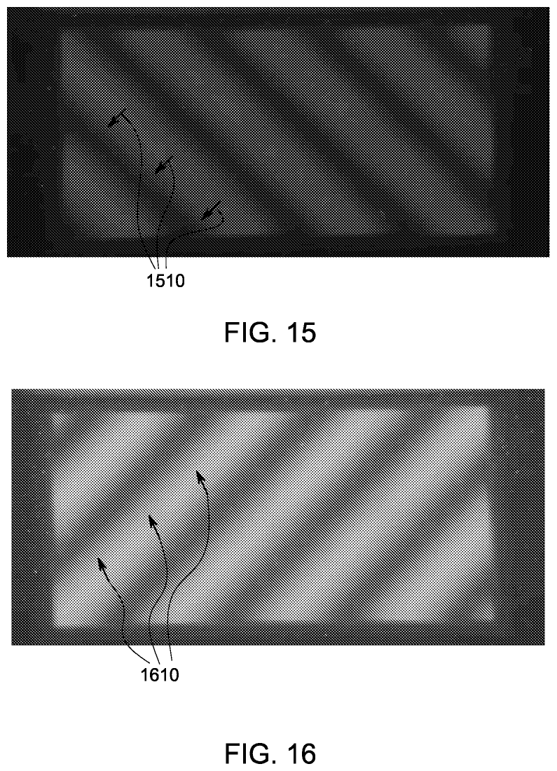

An exemplary pattern sequence (in one or more colors) presented by the grid can begin with the display of FIG. 6, which depicts a static ring pattern. FIG. 7 depicts an elongate octagon/polygon, followed by an oval in FIG. 8. FIG. 9 depicts a rectangle, and FIGS. 10, 11, 12 and 13 respectively show a line on the left, right, top and bottom of the scene. FIG. 14 shows opposing brackets. FIGS. 15 and 16 define a sequence of diagonal sinusoidal intensity patterns that are translated (phase-shifted) (arrows 1510 and 1610, respectively) in a dynamic manner. Such patterns, and others herein, can be used in various analysis techniques, including computational imaging methods/techniques such as phase-shift deflectometry and photometric stereo. Similarly, the entire grid, or an equal distribution of LEDs across the grid, can be operated to generate a full field of light on the object surface(s). Such computational imaging methods/techniques can be implemented in a manner clear to those of skill.

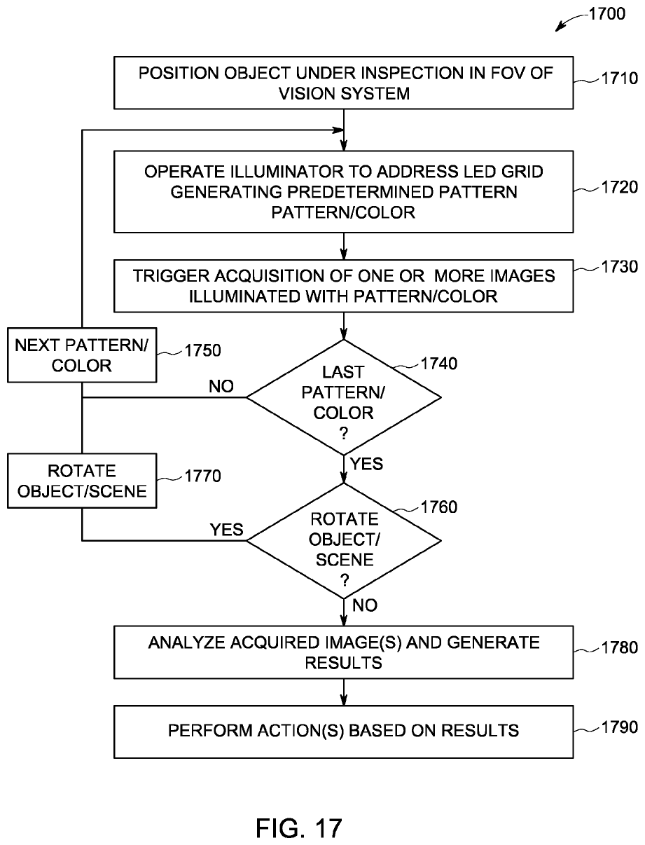

In operation, the vision system processor 120 can trigger illumination and image acquisition, or the illuminator and the camera image acquisition trigger signal can be tied via the controller to the processor to provide triggers as the illuminator and camera achieves each desired state. With reference to FIG. 17, a generalized operational procedure 1700 is shown and described. An object under inspection (or for which another vision system task is desired, such as barcode decoding) is positioned within the field of view (FOV) of the vision system in step 1710. The orientation can be chosen to enhance visibility of one or more features of interest on the object. After placement, the illumination system is operated according to a program to generate a desired pattern in a desired color in the grid (step 1720). That is, a serial signal is transmitted to the grid's control bus by the microcontroller, and predetermined LEDs are switched on for a predetermined time frame. While illuminated, the camera image sensor is triggered in step 1730 to acquire one or more images of the illuminated object. The pattern and/or color can be selected to enhance certain features of interest. The procedure 1700 then determines if the previously presented pattern and/or color is the last in the sequence (decision step 1740). If more patterns and/or colors are specified, the next pattern and/or color in the sequence is selected (step 1750). When a specified sequence of patterns and/or colors have been completed, and associated images have been acquired therewith, the procedure 1700 queries (decision step 1760) whether a new position for the object with respect to the illuminator is desired. If so, then the object and/or illuminator is moved—for example rotated 90 degrees to reorient it relative to the wide dimension—in step 1770 and the same, or new, sequence of patterns/colors is presented while images are acquired in steps 1720-1750. Rotation or movement of the object or illuminator can occur with mechanical assistance or manually. Rotation can also occur if sufficient results were not achieved in the first orientation. Either during or after acquisition of one or more image(s), the procedure 1700 analyzes the image data using various tools, algorithms, and other processes in step 1780, and produces desired results—for example, identifying a defect or passing an acceptable object. These results are used to perform various actions in step 1790. Such actions can include registering a passing indication, sounding an alert or operating a part rejection function.

More particularly, the vison system processor 120 can be arranged to employ image frames acquired in association with the presentation of each of a plurality of illumination patterns (via controller 130), in one or more colors to form a single (or plurality of) resulting image(s), or otherwise derive information on features of interest in the scene. The processor 120 can direct the illuminator 132 to undertake a desired pattern while imaging a scene, and operate on the resulting image frames, and or can progressively analyze one or more acquired frames and vary the presented color or pattern, in an ongoing basis, to enhance certain features as appropriate. In one example, a subset of a group of captured image frames associated with various illumination patterns can be used to capture one or more separate aspects of the scene.

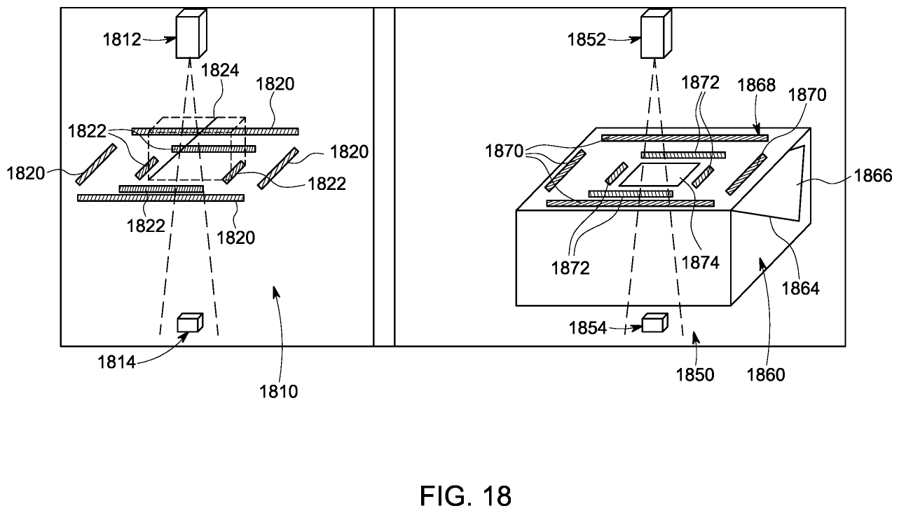

FIG. 18 shows, by way of non-limiting example, a conventional vision system camera arrangement 1810 in comparison to a vision system arrangement 1850 employing a version of the exemplary illumination assembly 1860 according to an illustrative embodiment herein. Both the conventional arrangement 1810 and illustrative arrangement 1850 employ a respective vision system camera (and associated processes/ors) 1812 and 1852 to acquire and analyze objects under inspection 1814 and 1854. The vision system processor in each arrangement 1810 and 1850 can trigger image acquisition in synchronization with various lighting effects. Notably, the conventional arrangement 1810 provides eight separate light bars 1820 and 1822 in two nested rectangles in addition to a central diffuse light element 1824 to generate a desired effect. This setup generally requires three discrete light controllers interfaced with the camera processor, wherein the bar controllers require four ports. While the bars 1820, 1822 can be arranged to generate different color lights, they may be relatively limited in the pattern presented by their fixed geometric placement relative to the camera 1812 and imaged scene.

Conversely, the illustrative arrangement 1860 uses the illumination panel assembly 1866 and beam splitter 1864 to generate a substantially similar lighting pattern (in terms of both placement and color) within a similarly located virtual/mirrored position 1868 with respect to the scene and object 1854. Hence the panel assembly 1866 can generate similarly colored nested rectangular bars 1870 and 1872 as well as a central diffuse light 1874. This is accomplished using a single, commercially available grid/panel assembly (possibly consisting of multiple series-connected grid components), and a single controller therefor. This illustrative arrangement 1860, therefore avoids the cost and complexity of multiple, discretely placed light elements and associated controllers. Moreover, the arrangement 1860 allows the presented light pattern and color to be varied, in both a static and dynamic manner to achieve effects not available in the conventional lighting arrangement 1810.

It should be clear that the above-described system and method effectively utilizes a rectangular-shaped light source in conjunction with a vision system camera assembly to increase angular coverage and reduce the working distance of the mirrored LED grid. The rectangular design provides a wider angle of light coverage in larger dimension of the light source. Using color, individually addressable LEDs (or similar light sources) reduces the complexity and cost of illumination assembly. Likewise, the programmable illumination head assembly described herein enables the creation of “pseudo” color images with mono cameras, which increases image resolution compared to Bayer filter color cameras. The ability to program the color display provides greater flexibility in inspection and imaging applications.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, as used herein, the terms “process” and/or “processor” should be taken broadly to include a variety of electronic hardware and/or software based functions and components (and can alternatively be termed functional “modules” or “elements”). Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Additionally, as used herein various directional and dispositional terms such as “vertical”, “horizontal”, “up”, “down”, “bottom”, “top”, “side”, “front”, “rear”, “left”, “right”, and the like, are used only as relative conventions and not as absolute directions/dispositions with respect to a fixed coordinate space, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances of the system (e.g. 1-5 percent). Accordingly, this description is meant to be taken only by way of example, and not to otherwise limit the scope of this invention.

What is claimed is:

1. A vision system comprising:
a vision system camera configured to acquire images of a scene at a predetermined focal plane;
an illumination assembly comprising a grid of individually addressable light sources;
a beam splitter positioned at an angle with respect to the predetermined focal plane such that either an optical axis of the vision system camera or an illumination from the illumination assembly extends through the beam splitter onto the scene; and
at least one processor in communication with the vision system camera and the illumination assembly and configured to:
control individual intensities of the individually addressable light sources to produce a discrete lighting pattern; and
control image acquisition in association with the discrete lighting pattern.

2. The vision system as set forth in claim 1, wherein the at least one processor is configured to control image acquisition by generating image acquisition triggers to the vision system camera, the image acquisition triggers synchronized with a presentation of the discrete lighting pattern.

3. The vision system as set forth in claim 1, wherein the individually addressable light sources comprise at least one of multicolor LEDs, IR LEDs, or UV LEDs.

4. The vision system as set forth in claim 2, wherein the at least one processor is constructed and arranged to address the individually addressable light sources via a serial data bus.

5. The vision system as set forth in claim 4, wherein the grid comprises a plurality of discrete arrays of individually addressable light sources connected by the serial data bus.

6. The vision system as set forth in claim 2, wherein the at least one processor is configured to generate a plurality of static or dynamic illumination patterns to illuminate the scene in an emission spectra.

7. The vision system as set forth in claim 6, wherein the vision system camera is triggered to acquire the images based upon illumination by each of a plurality of static or dynamic illumination patterns.

8. The vision system as set forth in claim 6, wherein the dynamic illumination patterns include a plurality of spatial sinewave gratings, each with distinct phase, spatial-frequency, and angle.

9. The vision system as set forth in claim 6, wherein the dynamic illumination patterns define a plurality of lines, each having a position and orientation.

10. The vision system as set forth in claim 1, wherein the grid and the beam splitter are enclosed in a housing with openings along the optical axis.

11. The vision system as set forth in claim 1, further comprising a diffusive surface that diffuses light from the individually addressable light sources.

12. The vision system as set forth in claim 1, wherein the at least one processor is constructed and arranged to vary the discrete lighting pattern based upon characteristics of features in the scene, and acquire images associated with each variation.

13. The vision system as set forth in claim 12, wherein the at least one processor is constructed and arranged to combine the acquired images and analyze features therein.

14. The vision system as set forth in claim 12, wherein the at least one processor is constructed and arranged to vary the discrete lighting pattern based upon analyzed features in prior acquired images of the scene.

15. The vision system as set forth in claim 1, wherein the illumination assembly and the at least one processor are constructed and arranged to, respectively, present the discrete lighting pattern, and process the acquired images, based upon computational imaging techniques.

16. The vison system as set forth in claim 15, wherein the computational imaging techniques include at least one of deflectometry or photometric stereo techniques.

17. The vision system as set forth in claim 1, wherein the emission spectrum is at least one of a visible spectrum, IR spectrum, or UV spectrum.

18. The vision system as set forth in claim 1, wherein the grid comprises a width greater than a length.

19. The vision system as set forth in claim 1, wherein the angle of the beam splitter with respect to the predetermined focal plane is approximately 45 degrees.

20. A system for illuminating a scene as imaged by a vision system camera at a predetermined focal plane, the system comprising:
an illumination assembly comprising a grid of individually addressable light sources;
a beam splitter positioned at an angle with respect to the predetermined focal plane such that either an optical axis of the vision system camera or an illumination from the illumination assembly extends through the beam splitter onto the scene; and
at least one processor in communication with the illumination assembly and the vision system camera and configured to:
control individual intensities of the individually addressable light sources to produce a discrete lighting pattern; and
provide control signals to the vision system camera based on the discrete lighting pattern.

21. A method for illuminating a scene as imaged by a vision system camera at a predetermined focal plane, the method comprising:
producing a discrete lighting pattern onto the scene by:
controlling individual intensities of individually addressable light sources arranged in a grid; and
directing either an optical axis of the vision system camera or illumination from the individually addressable light sources through a beam splitter onto the scene; and
providing control signals to the vision system camera based on the discrete lighting pattern.

22. The method as set forth in claim 21, wherein the control signals to the vision system camera are synchronized with presentation of the discrete lighting patterns by the grid.

23. The method as set forth in claim 21, further comprising generating a plurality of static or dynamic illumination patterns to illuminate the scene in one or more emission spectra.

24. The method as set forth in claim 23, further comprising presenting the dynamic illumination patterns to provide a plurality of spatial sinewave gratings, each with a distinct phase, a spatial-frequency, and an angle.

25. The method as set forth in claim 22, further comprising varying the discrete lighting pattern based upon characteristics of features in the scene, and providing the control signals to the vision system camera in association with each variation.

26. The method as set forth in claim 25, further comprising combining acquired images from each variation and analyzing features therein.

27. The method as set forth in claim 26, further comprising varying the discrete lighting pattern based upon analyzed features in prior acquired images of the scene.

28. The method as set forth in claim 22, further comprising presenting the discrete lighting pattern, and processing the acquired images, based upon computational imaging techniques.

29. The method as set forth in claim 28, wherein the computational imaging techniques include at least one of deflectometry techniques or photometric stereo techniques.
